(19) United States
(12) Patent Application Publication
(10) Pub. No.: US 2007/0045252 A1
(43) Pub. Date: Mar. 1, 2007

(54) Laser induced plasma machining with a process gas

(76) Inventors: Klaus Kleine, Los Gatos, CA (US); Scott Palley, Fremont, CA (US); Frank Korte, Hannover (DE)

Correspondence Address: SQUIRE, SANDERS & DEMPSEY LLP, 1 MARITIME PLAZA, SUITE 300, SAN FRANCISCO, CA, 94111, US

(21) Appl. No.: 11/210,289

(22) Filed: Aug. 23, 2005

(51) Int. Cl. B23K 26/00; B23K 10/00

(52) U.S. Cl. 219/121.69; 219/121.44

(57) ABSTRACT

Embodiments of methods of laser machining that include inducing formation of a plasma plume from a process gas through interaction of the gas with a laser beam are disclosed. The methods may include removing material from the substrate by interaction of the induced plasma plume with the substrate.

### BACKGROUND OF THE INVENTION

1. Field of the Invention

This invention relates to laser induced plasma machining for use in fabricating devices. In particular, the invention relates to fabricating implantable medical devices such as stents using laser induced plasma machining.

2. Description of the State of the Art

This invention relates to laser machining of devices such as stents. Laser machining refers to removal of material accomplished through laser and target material interactions. Generally speaking, these processes include laser drilling, laser cutting, and laser grooving, marking or scribing. Laser machining processes transport photon energy into a target material in the form of thermal energy or photochemical energy. Material is removed by melting and blow away, or by direct vaporization/ablation.

The application of ultrashort-pulse lasers for high quality laser material processing is particularly useful due to the extremely high intensity (>10¹² W/cm²), ultrashort-pulse duration (<1 picosecond), and non-contact nature of the processing. Ultrashort lasers allow precise and efficient processing, especially at the microscale. Compared with long-pulse lasers and other conventional manufacturing techniques, ultrashort lasers provide precise control of material removal, can be used with an extremely wide range of materials, produce negligible thermal damage, and provide the capability for very clean small features. These features make ultrashort-pulse lasers a promising tool for microfabrication, thin film formation, laser cleaning, and medical and biological applications.

However, laser machining of a substrate tends to result in a heat affected zone. The heat affected zone is a region on the target material that is not removed, but is affected by heat due to the laser. The properties of material in the zone can be adversely affected by heat from the laser. Therefore, it is generally desirable to reduce or eliminate heat input beyond removed material, thus reducing or eliminating the heat affected zone.

One of the many medical applications for laser machining includes fabrication of radially expandable endoprostheses, which are adapted to be implanted in a bodily lumen. An “endoprosthesis” corresponds to an artificial device that is placed inside the body. A “lumen” refers to a cavity of a tubular organ such as a blood vessel.

A stent is an example of such an endoprosthesis. Stents are generally cylindrically shaped devices, which function to hold open and sometimes expand a segment of a blood vessel or other anatomical lumen such as urinary tracts and bile ducts. Stents are often used in the treatment of atherosclerotic stenosis in blood vessels. “Stenosis” refers to a narrowing or constriction of the diameter of a bodily passage or orifice. In such treatments, stents reinforce body vessels and prevent restenosis following angioplasty in the vascular system. “Restenosis” refers to the reoccurrence of stenosis in a blood vessel or heart valve after it has been treated (as by balloon angioplasty, stenting, or valvuloplasty) with apparent success.

The treatment of a diseased site or lesion with a stent involves both delivery and deployment of the stent. “Delivery” refers to introducing and transporting the stent through a bodily lumen to a region, such as a lesion, in a vessel that requires treatment. “Deployment” corresponds to the expanding of the stent within the lumen at the treatment region. Delivery and deployment of a stent are accomplished by positioning the stent about one end of a catheter, inserting the end of the catheter through the skin into a bodily lumen, advancing the catheter in the bodily lumen to a desired treatment location, expanding the stent at the treatment location, and removing the catheter from the lumen.

In the case of a balloon expandable stent, the stent is mounted about a balloon disposed on the catheter. Mounting the stent typically involves compressing or crimping the stent onto the balloon. The stent is then expanded by inflating the balloon. The balloon may then be deflated and the catheter withdrawn. In the case of a self-expanding stent, the stent may be secured to the catheter via a retractable sheath or a sock. When the stent is in a desired bodily location, the sheath may be withdrawn which allows the stent to self-expand.

The stent must be able to satisfy a number of mechanical requirements. First, the stent must be capable of withstanding the structural loads, namely radial compressive forces, imposed on the stent as it supports the walls of a vessel. Therefore, a stent must possess adequate radial strength. Radial strength, which is the ability of a stent to resist radial compressive forces, is due to strength and rigidity around a circumferential direction of the stent. Radial strength and rigidity, therefore, may also be described as, hoop or circumferential strength and rigidity.

Once expanded, the stent must adequately maintain its size and shape throughout its service life despite the various forces that may come to bear on it, including the cyclic loading induced by the beating heart. For example, a radially directed force may tend to cause a stent to recoil inward. Generally, it is desirable to minimize recoil.

In addition, the stent must possess sufficient flexibility to allow for crimping, expansion, and cyclic loading. Longitudinal flexibility is important to allow the stent to be maneuvered through a tortuous vascular path and to enable it to conform to a deployment site that may not be linear or may be subject to flexure. Finally, the stent must be biocompatible so as not to trigger any adverse vascular responses.

The structure of a stent is typically composed of scaffolding that includes a pattern or network of interconnecting structural elements often referred to in the art as struts or bar arms. The scaffolding can be formed from wires, tubes, or sheets of material rolled into a cylindrical shape. The scaffolding is designed so that the stent can be radially compressed (to allow crimping) and radially expanded (to allow deployment).

Stents have been made of many materials such as metals and polymers, including biodegradable polymeric materials. Biodegradable stents are desirable in many treatment applications in which the presence of a stent in a body may be necessary for a limited period of time until its intended function of, for example, achieving and maintaining vascular patency and/or drug delivery is accomplished.

Stents can be fabricated by forming patterns on tubes or sheets using a laser cutting. Laser machining is well-suited to forming the fine intricate patterns of structural elements in stents. However, as indicated above, the use of laser machining can have adverse effects on mechanical and other properties in a heat affected zone. Therefore, it is also desirable to reduce or eliminate the heat affected zone resulting from laser machining processes of stents.

### SUMMARY OF THE INVENTION

Certain embodiments of the present invention include a method of laser machining a substrate for fabricating an implantable medical device including inducing formation of a plasma plume from a process gas through interaction of the gas with a laser beam focused on a substrate. The method may further include removing material in selected regions from the substrate by interaction of a plasma plume with the substrate.

Further embodiments of the present invention include a method of fabricating an implantable medical device including directing a laser beam on selected regions of a substrate, the selected regions being adjacent or exposed to a process gas. The method may further include allowing a plasma induced by interaction of the laser beam with the process gas to remove material from the substrate.

Additional embodiments of the present invention include a method of fabricating a biodegradable stent including directing a laser energy to a substrate for a biodegradable stent such that the laser energy is directed in the presence of a process gas. A kerf width of removed material for the substrate may be increased over a kerf width of removed material when directing laser energy to the substrate in an absence of a process gas.

### BRIEF DESCRIPTION OF THE DRAWINGS

FIG. 1 depicts a mathematical representation of a Gaussian laser beam profile.

FIG. 2 depicts a collimated two-dimensional representation of a laser beam.

FIG. 3 depicts an overhead view of the surface of a substrate.

FIG. 4 illustrates a kerf machined by a laser.

FIG. 5 depicts a laser beam focused by a lens onto a substrate.

FIG. 6 depicts laser beam diameter and the plasma formation time in the plasma formation region from modeling studies.

FIG. 7 is an overhead view of a substrate that depicts an area or region of direct interaction of a laser beam.

FIG. 8 depicts a three-dimensional representation of a stent.

FIG. 9 is an elevation view, partially in section, of a stent which is mounted on a rapid-exchange delivery catheter and positioned within an artery.

FIG. 10 is an elevation view, partially in section, similar to that shown in FIG. 1, wherein the stent is expanded within the artery so that the stent embeds within the arterial wall.

FIG. 11 is an elevation view, partially in section, showing the expanded stent implanted within the artery after withdrawal of the rapid-exchange delivery catheter.

FIG. 12 depicts an embodiment of a portion of a machine-controlled system for laser machining a tube.

FIG. 13 depicts a general schematic of a laser system.

FIG. 14 depicts a side view of a laser machining apparatus.

FIG. 15 depicts an overhead view of a laser machining apparatus.

FIG. 16 depicts a close-up axial view of a region where a laser beam interacts with a tube.

FIG. 17 depicts a close-up end view of a region where a laser beam interacts with a tube.

### DETAILED DESCRIPTION OF THE INVENTION

Embodiments of the present invention employ ultrashort-pulse lasers in laser machining of substrates. These embodiments are suitable for fabricating fine and intricate structures of implantable medical devices such as stents. “Ultrashort-pulse lasers” refer to lasers having pulses with durations shorter than about a picosecond (=10⁻¹²) Ultrashort-pulse lasers can include both picosecond and femtosecond (=10⁻¹⁵) lasers. The ultrashort-pulse laser is clearly distinguishable from conventional continuous wave and long-pulse lasers (nanosecond (10⁻⁹) laser) which have significantly longer pulses. Certain embodiments of the present method may employ femtosecond lasers that may have pulses shorter than about 10⁻¹³ second.

The ultrashort-pulse lasers are known to artisans. For example, they are thoroughly disclosed by M. D. Perry et al. in Ultrashort-Pulse Laser Machining, Section K-ICALEO 1998, pp. 1-20. Representative examples of femtosecond lasers include, but are not limited to a Ti:sapphire laser (735 nm-1035 nm) and an excimer-dye laser (220 nm-300 nm, 380 nm-760 nm).

Longer-pulse lasers remove material from a surface principally through a thermal mechanism. The laser energy that is absorbed results in a temperature increase at and near the absorption site. As the temperature increases to the melting or boiling point, material is removed by conventional melting or vaporization. Depending on the pulse duration of the laser, the temperature rise in the irradiated zone may be very fast, resulting in thermal ablation and shock. An advantage of ultrashort-pulse lasers over longer-pulse lasers is that the ultrashort-pulse deposits its energy so fast that is does not interact with the plume of vaporized material, which would distort and bend the incoming beam and produce a rough-edged cut.

Unlike long-pulse lasers, ultrashort-pulse lasers allow material removal by a nonthermal mechanism. Extremely precise and rapid machining can be achieved with essentially no thermal ablation and shock. The nonthermal mechanism involves optical breakdown in the target material which results in material removal. As discussed below, optical breakdown may also occur with a gas, in particular with a process gas. Optical breakdown tends to occur at a certain threshold intensity of laser radiation that is material dependent. Specifically each material has its own laser-induced optical breakdown threshold which characterizes the intensity required to ablate the material at a particular pulse width.

During optical breakdown of material, a very high free electron density, i.e., plasma, is produced. The plasma can be produced through mechanisms such as multiphoton absorption and avalanche ionization.

In optical breakdown, a critical density plasma is created in a time scale much shorter than electron kinetic energy is transferred to the lattice. The resulting plasma is far from thermal equilibrium. The target material is converted from its initial solid-state directly into a fully ionized plasma on a time scale too short for thermal equilibrium to be established with a target material lattice. Therefore, there is negligible heat conduction beyond the region removed. As a result, there is negligible thermal stress or shock to the material beyond approximately 1 micron from the laser machined surface.

In conventional laser machining with longer-pulse and ultra-fast pulse lasers, material removal tends to occur in an area or region of direct interaction of a laser beam with the target material or substrate. Laser machining typically involves focusing a laser beam onto an area or region of the substrate. The area of direct interaction corresponds to a focus diameter (Df) on the target material that can be calculated from:
Df=1.27*f*λ/D
where f is the focal length of a focusing optic, λ is the wave length of the laser, and D is the beam diameter on the optic.

Even ultrashort-pulse laser machining tends to result in a heat affected zone, i.e., a portion of the target substrate that is not removed, but is still heated by the beam. The heating may be due to exposure to the substrate from a section of the beam with an intensity that is not great enough to remove substrate material through either a thermal or nonthermal mechanism. For example, the portions of a beam near its edges may not have an intensity sufficiently high to induce formation of a plasma. Most beams have an uneven or nonuniform beam intensity profile, for example, a Gaussian beam profile.

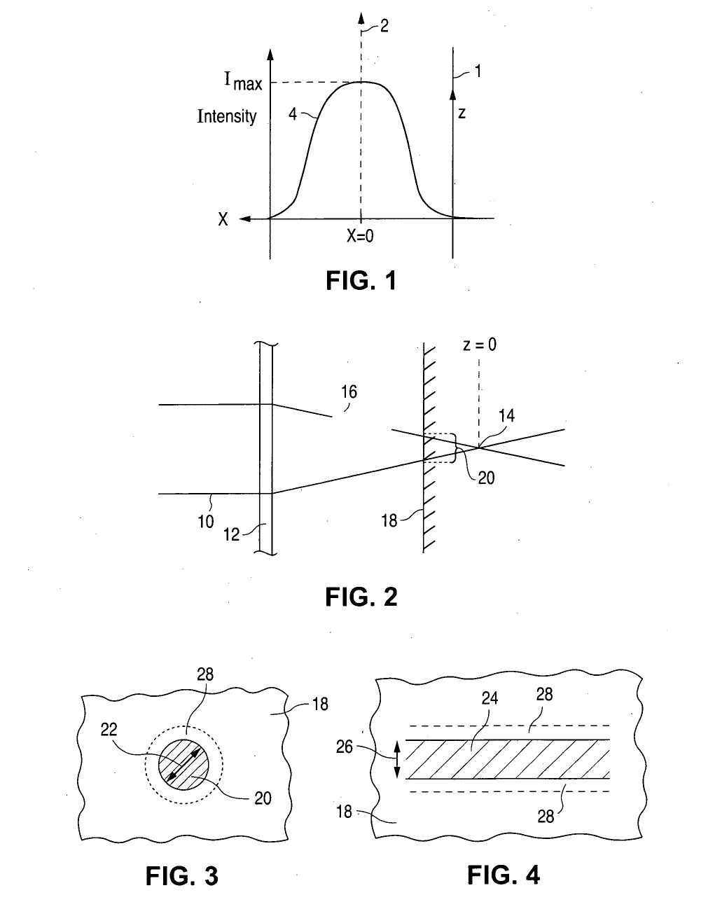

FIG. 1 depicts an axial cross-section of a laser beam 1 traveling in the “z” direction as indicated by an arrow 2. A mathematical representation 4 in the form of a Gaussian beam profile is shown superimposed on the beam. The profile has a maximum intensity (Iₘₐₓ) at the beam center (x=0) and then decreases with distance on either side of the maximum. The sections of the beam close to the edge may not remove material. However, such sections may still deposit energy into the material that can have undesirable thermal affects. Additionally, a portion of the substrate may also be heated through conduction.

A heat affected zone in a target substrate is undesirable for a number of reasons. In both metals and polymers, heat can cause thermal distortion and roughness at the machined surface. The heat can also alter properties of a polymer such as mechanical strength and degradation rate. The heat can cause chemical degradation that can affect the mechanical properties and degradation rate.

Additionally, heat can modify molecular structure of a polymer, such as degree of crystallinity and polymer chain alignment. Mechanical properties are highly dependent on molecular structure. For example, a high degree of crystallinity and/or polymer chain alignment is associated with a stiff, high modulus material. Heating a polymer above its melting point can result in an undesirable increase or decrease in crystallinity once the polymer resolidifies. Melting a polymer may also result in a loss of polymer chain alignment, which can adversely affect mechanical properties.

In addition, since heat from the laser modifies the properties of the substrate locally, the mechanical properties may be spatially nonuniform. Such nonuniformity may lead to mechanical instabilities such as cracking.

FIGS. 2-4 are schematic illustrations of laser machining a substrate. FIG. 2 depicts a collimated two-dimensional representation of a laser beam 10 passing through a focusing lens 12 with a focal point 14. A focused laser beam 16 decreases in diameter with distance from lens 12. Beam 16 impinges on a substrate 18. Area 20 corresponds to the region of direct interaction of the laser.

FIG. 3 depicts an overhead view of the surface of substrate 18 showing area 20 which has a diameter 22. Laser beam 10 removes material at least in area 20. FIG. 4 illustrates that translation of the laser beam or substrate allows the laser beam to cut a trench or kerf 24 with at least a width 26 which is the same as diameter 22. At least some of the material in region 28 is not removed. However, the material not removed is heated by the beam. Region 28 corresponds to a heat affected zone.

During laser induced breakdown, a minimum threshold intensity, Iₜₕ, is required before breakdown occurs: for I<Iₜₕ, no breakdown, while I≧Iₜₕ results in breakdown. “I” is the laser intensity (e.g., W/m²) of a pulse at any axial position or time along the direction of the beam. The intensity is dependent on both time (t) and the axial distance along the beam (z), I(z, t). It has been experimentally observed that the breakdown region initially forms at the focal point (z=0), then expands up the beam path toward the laser source. Plasma Absorption of Femtosecond Laser Pulses in Dielectrics, C. H. Fan, J. Sun, and J. P. Longtin, Journal of Heat Transfer, Vol. 124, April 2002.

The intensity, I(z, t) may be separated into a temporal pulse, P(t), and position dependent irradiated area, A(z). P(t) may have a functional form similar to a Gaussian distribution with a maximum, Pₘₐₓ. Optical breakdown is expected to occur when Pₘₐₓ/Pₜₕ is greater than one, where Pₜₕ is the threshold temporal pulse intensity.

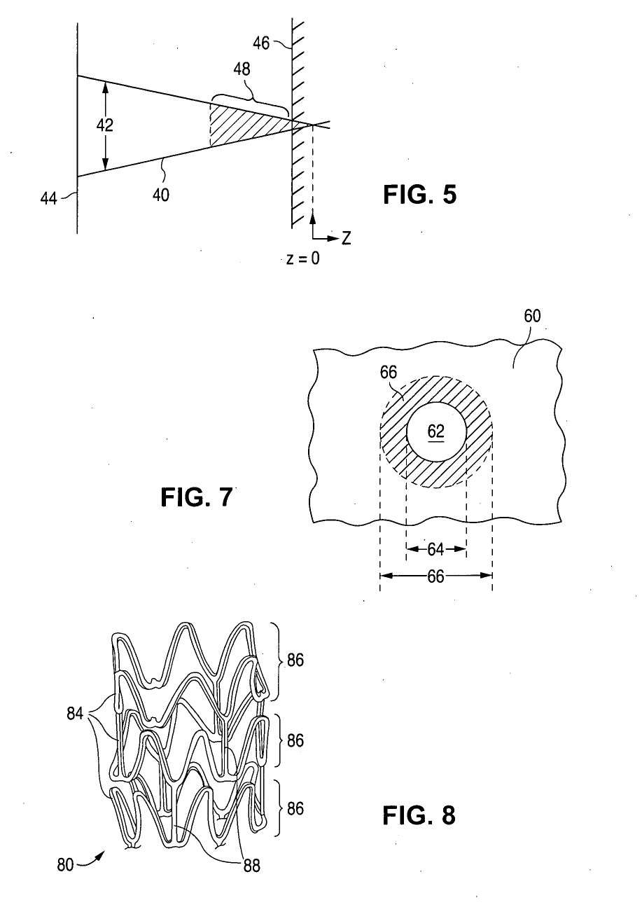

As an illustration, FIG. 5 depicts a beam 40 with a beam variable diameter 42 focused by a lens 44 and directed at a substrate 46. At a given intensity above the threshold intensity, a plasma region 48 is expected to form. As indicated above, it has been shown from modeling results of femtosecond induced optical breakdown that as the intensity increases above the threshold intensity, the plasma region expands along the axis of the beam. Plasma Absorption of Femtosecond Laser Pulses in Dielectrics, C. H. Fan, J. Sun, and J. P. Longtin, Journal of Heat Transfer, Vol. 124, April 2002.

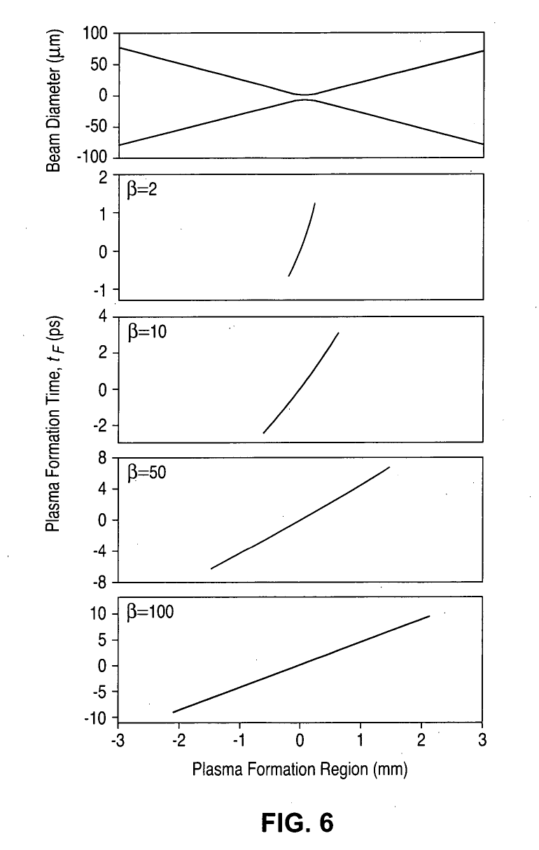

The modeling studies referred to above showed that as the ratio Pₘₐₓ/Pₜₕ increases above one, plasma formation time or plasma lifetime increases. FIG. 6 from FIG. 4 of C. H. Fan et al. depicts the beam diameter of the plasma formation region. FIG. 6 also includes the plasma formation time in the plasma formation region for different values of β(=Pₘₐₓ/Pₜₕ). The length of the plasma region along the axis of the beam increases, along with the maximum diameter of the plasma region. As a result, a larger area may be machined with a plasma.

As indicated above, laser machining through a nonthermal mechanism, i.e., a plasma induced by ultrashort-pulse laser results in negligible thermal affects adjacent or exposed to removed material. Thus, it is desirable to laser machine the target material with a plasma.

A plasma plume may be induced from a process gas through optical breakdown of the gas as well as from a target material. Various embodiments of a method may include inducing formation of a plasma plume from a process gas through interaction of the gas with a laser beam focused on a substrate. In certain embodiments, a method of fabricating a device may include directing a laser beam on selected regions of a substrate that are adjacent or exposed to a process gas. The target material or substrate and laser beam may be in a process area or chamber containing the process gas. The method may further include allowing a plasma induced by interaction of the laser beam with the process gas to remove material from the substrate. Material may be removed in selected regions from the substrate by interaction of a plasma plume with the substrate.

In some embodiments, an area of removed material may be greater than an area of of direct interaction of the laser beam with the substrate. As indicated above, an area of direct interaction of a laser beam on a substrate corresponds to a region with a focus diameter (Df) on the substrate. Thus, a kerf width of removed material for the substrate may be increased over a kerf width of removed material in an absence of a process gas.

As described above, plasma may be formed by, for example, multiphoton absorption, avalanche, or some other mechanism. The plasma plume induced from a substrate material can remove substrate material. In a similar manner, the plasma plume induced from the process gas may also remove substrate material.

As shown in FIG. 3, directing a laser at a substrate in the absence of a process gas tends to remove material in the region of direct interaction of the beam with the substrate. However, a plasma plume induced from a process gas may allow removal of material from a region larger than the area of direct interaction of the laser.

As an illustration, FIG. 7 is an overhead view of a substrate 60 that depicts an area or region 62 of direct interaction of a laser beam with a diameter 62. In the absence of a process gas, material in region 62 is removed. A region including a region 66 and region 62 can be removed when induced plasma is formed by directing a laser beam at the substrate with a process gas. It is believed that the plasma formed from the process gas can substantially increase the area machined.

As described above, ultrashort-pulse lasers can machine with a plasma induced through interaction with target material. However, removal of material is limited to the area or region of direct interaction of the laser with the target material. In addition, such methods can result in the undesirable thermal affects caused by a nonuniform beam profile depicted in FIG. 1.

In contrast, as described above, embodiments of the present method involve plasma machining with a plasma induced by a process gas. The induced plasma from a process gas may machine a region larger than a region of direct laser interaction with the target material. Therefore, the plasma may remove an additional region of material (e.g., region 66 in FIG. 7) that would be left behind by plasma machining with plasma solely induced through interaction of the laser with the substrate material.

As described above, due to a nonuniform beam profile, at least a part of the additional region left behind by laser machining without a process gas may have undesirable thermal affects. Furthermore, due to the nature of plasma interactions with a substrate described above, there may tend to be negligible heat input into regions outside of the regions where material is removed when machining with a process gas. Therefore, the heat affected zone may be reduced or eliminated.

In one embodiment, a femtosecond laser may be used that generates a laser beam with a pulse length between about 10 and about 500 fs. In other embodiments, a pulse length less than about 10 fs may be used. Additionally, inducing a plasma from a process gas may require a femtosecond laser with a peak pulse power of at least about 50 megawatts.

Various types of process gases may be used for laser induced machining. Representative process gases that may be used, include, but are not limited to helium, argon, oxygen, nitrogen, carbon dioxide, air, or combinations thereof. The gas used can be pure helium, argon, nitrogen, or carbon dioxide, i.e., greater than 99% by volume, preferably greater than 99.9% purity.

The lifetime and spatial extent of the plasma formation region may depend upon the ionization threshold of the process gas used. The formation of plasma from a gas is dependent on the ionization threshold of the process gas. The spatial extent includes both the size along the axis of the beam and the radial extent of the region. The radial extent of the plasma region corresponds to the kerf width that can be cut by the laser.

It is expected that a process gas having a larger ionization threshold will result in a longer lifetime and larger spatial extent of the plasma region. A plasma plume with a longer lifetime will interact longer with the material and thus remove more material. Therefore, a plasma region with a larger spatial extent and a longer lifetime may tend to result in a larger kerf width.

In some embodiments, the process gas may be selected to control the spatial extent or size of the plasma region, and thus a desired kerf width. The desired kerf width may depend on a desired end product of maching, i.e., the size of the features that are to be formed. For example, stent patterns with thinner, finer structural elements may require a smaller kerf width than other stent patterns. Selecting a process gas that results in a smaller kerf width may reduce the amount of over-cutting of a substrate.

Alternatively, a larger kerf width may be desired for cutting structures that have larger or wider structural elements. Selecting a process gas that results in a larger kerf width may reduce the amount of under-cutting of a substrate.

In some embodiments, the process gas may be optimized or selected to achieve a desired machining effect. In an embodiment, a desired machining effect may be a desired kerf width. Thus, a process gas may be selected to obtain a desired kerf width. The selected process gas may be a gas with a selected composition or a type of gas. In an embodiment, the process gas may be selected to obtain a desired increase in a kerf width of the removed material over a kerf width of removed material in an absence of a process gas.

It is expected that a gas with a higher/lower ionization potential may result in a larger plasma plume with a longer lifetime, resulting in a larger/smaller kerf width. In one embodiment, a gas with a lower ionization potential may replace a gas with a higher ionization potential to decrease the size of a kerf width. Alternatively, a process chamber including a gas with a lower ionization potential may be diluted with a gas with a higher ionization potential to decrease the size of the kerf width. For example, a process chamber containing air may be purged partially or completely with helium, which has a lower ionization potential than air. For instance, for a process gas including helium and another gas or combination of other gases with a higher ionization potential, the process gas can include 10-100%, 20-100%, 30-100%, 40-100%, 50-100%, 60-100%, 70-100%, 80-100%, 90-100%, or 95-100% helium.

As indicated above, embodiments of the laser machining method described above may be used in the fabrication of implantable medical devices such as stents. In general, stents can have virtually any structural pattern that is compatible with a bodily lumen in which it is implanted. Typically, a stent is composed of a pattern or network of circumferential rings and longitudinally extending interconnecting structural elements of struts or bar arms. In general, the struts are arranged in patterns, which are designed to contact the lumen walls of a vessel and to maintain vascular patency. A myriad of strut patterns are known in the art for achieving particular design goals. A few of the more important design characteristics of stents are radial or hoop strength, expansion ratio or coverage area, and longitudinal flexibility.

An exemplary structure of a stent is shown in FIG. 8. FIG. 8 depicts a three-dimensional view of a stent 80 which is made up of struts 84. Stent 80 has interconnected cylindrical rings 86 connected by linking struts or links 88. The embodiments disclosed herein are not limited to fabricating stents or to the stent pattern illustrated in FIG. 8. The embodiments are easily applicable to other stent patterns and other devices. The variations in the structure of patterns are virtually unlimited.

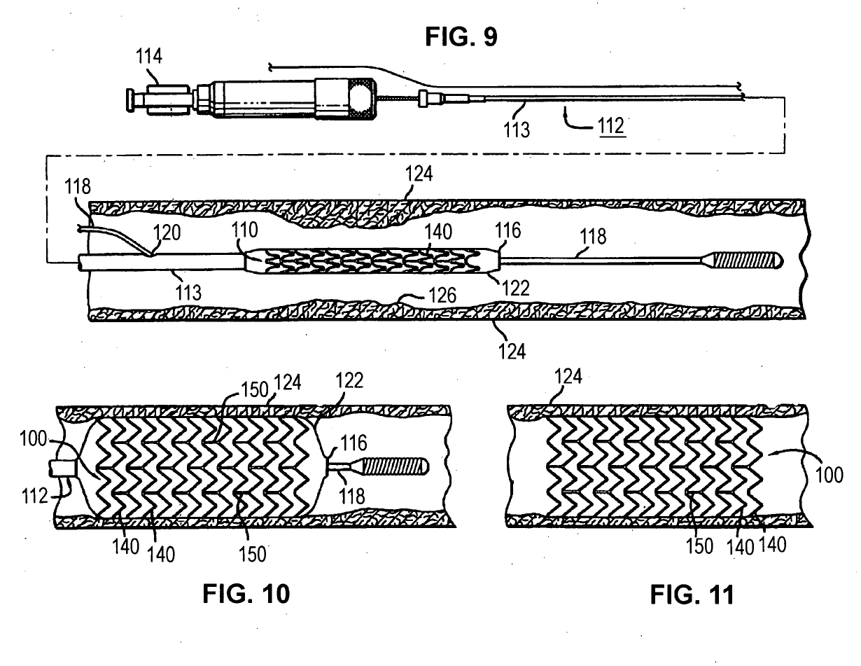

Additionally, an exemplary use of a stent is described in FIGS. 9-10. FIGS. 9-10 can represent any balloon expandable stent 100. FIG. 9 depicts a stent 100 with interconnected cylindrical rings 140 mounted on a catheter assembly 112 which is used to deliver stent 100 and implant it in a bodily lumen. Rings 140 are connected by links 150.

For example, a bodily lumen may include a coronary artery, peripheral artery, or other vessel or lumen within the body. The catheter assembly includes a catheter shaft 113 which has a proximal end 114 and a distal end 116. The catheter assembly is configured to advance through the patient's vascular system by advancing over a guide wire by any of the well-known methods of an over-the-wire system (not shown) or a well-known rapid exchange catheter system, such as the one shown in FIG. 9. The stent 100 in FIGS. 8-10 conceptually represents any type of stent well-known in the art, i.e., one having a plurality of rings 140.

Catheter assembly 112, as depicted in FIG. 9, includes a port 120 where the guide wire 118 exits the catheter. The distal end of guide wire 118 exits catheter distal end 116 so that the catheter advances along the guide wire on a section of the catheter between port 120 and catheter distal end 116. As is known in the art, the guide wire lumen which receives the guide wire is sized for receiving various diameter guide wires to suit a particular application. The stent is mounted on an expandable member 122 (e.g., a balloon) and is crimped tightly thereon, so that the stent and expandable member present a low profile diameter for delivery through the arteries.

As shown in FIG. 9, a partial cross-section of an artery 124 has a small amount of plaque that has been previously treated by angioplasty or other repair procedure. Stent 100 is used to repair a diseased or damaged arterial wall as shown in FIG. 9, or a dissection, or a flap, all of which are commonly found in the coronary arteries and other vessels. Stent 100, and other embodiments of stents, also can be placed and implanted without any prior angioplasty.

In a typical procedure to implant stent 100, guide wire 118 is advanced through the patient's vascular system by well-known methods, so that the distal end of the guide wire is advanced past the plaque or a diseased area 126. Prior to implanting the stent, the cardiologist may wish to perform an angioplasty or other procedure (i.e., atherectomy) in order to open and remodel the vessel and the diseased area. Thereafter, stent delivery catheter assembly 112 is advanced over the guide wire so that the stent is positioned in the target area. The expandable member or balloon 122 is inflated by well-known means so that it expands radially outwardly and in turn expands the stent radially outwardly until the stent is apposed to the vessel wall. The expandable member is then deflated and the catheter withdrawn from the patient's vascular system. The guide wire typically is left in the lumen for post-dilatation procedures, if any, and subsequently is withdrawn from the patient's vascular system. As depicted in FIGS. 10 and 11, the balloon is fully inflated with the stent expanded and pressed against the vessel wall. In FIG. 11, the implanted stent remains in the vessel after the balloon has been deflated and the catheter assembly and guide wire have been withdrawn from the patient.

Stent 100 holds open the artery after the catheter is withdrawn, as illustrated by FIG. 11. A stent may be formed from a cylindrical tube with a constant wall thickness, so that the straight and undulating or curved components of the stent are relatively flat in transverse cross-section. Thus, when the stent is expanded, a flat abluminal surface is pressed into the wall of the artery. As a result, the stent does not interfere with the blood flow through the artery. After the stent is pressed into the wall of the artery, it can become covered with endothelial cell growth which further minimizes blood flow interference. The undulating or curved portion of the stent provides good tacking characteristics to prevent stent movement within the artery. Because cylindrical rings 140 are closely spaced at regular intervals, they provide uniform support for the wall of the artery. Consequently the rings are well adapted to tack up and hold in place small flaps or dissections in the wall of the artery.

In general, a stent pattern is designed so that the stent can be radially expanded (to allow deployment) and crimped (to allow delivery). The stresses involved during expansion from a low profile to an expanded profile are generally distributed throughout various structural elements of the stent pattern. As a stent expands, various portions of the stent can deform to accomplish a radial expansion.

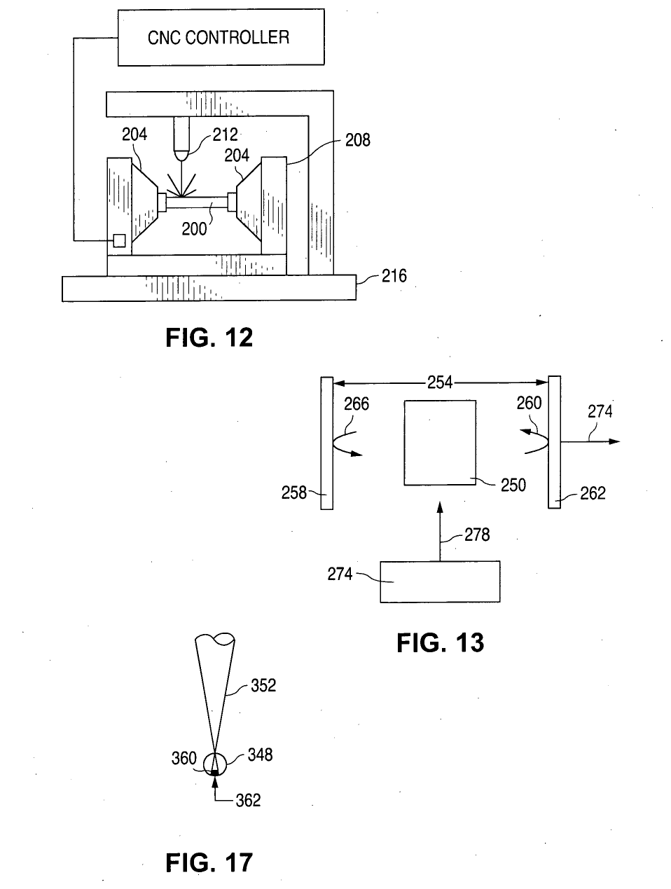

Stents and similar stent structures can be made in a variety of ways. A stent may be fabricated by machining a thin-walled tubular member with a laser. Selected regions of the tubing may be removed by laser machining to obtain a stent with a desired pattern. Alternatively, a stent may be fabricated by machining a sheet in a similar manner, followed by rolling and bonding the cut sheet to form the stent. The tubing may be cut using a machine-controlled laser as illustrated schematically in FIG. 12.

In some embodiments, the outer diameter of a fabricated stent in an unexpanded condition may be between about 0.2 mm and about 5.0 mm, or more narrowly between about 1 mm and about 3 mm. In an embodiment, the length of the stents may be between about 7 mm and about 9 mm, or more narrowly, between about 7.8 and about 8.2 mm.

Laser machining may used to fabricate stents from a variety of materials. For example, stent pattern may be cut into materials including polymers, metals, or a combination thereof. In particular, polymers can be biostable, bioabsorbable, biodegradable, or bioerodable. Biostable refers to polymers that are not biodegradable. The terms biodegradable, bioabsorbable, and bioerodable, as well as degraded, eroded, and absorbed, are used interchangeably and refer to polymers that are capable of being completely eroded or absorbed when exposed to bodily fluids such as blood and can be gradually resorbed, absorbed, and/or eliminated by the body. In addition, a medicated stent may be fabricated by coating the surface of the stent with an active agent or drug, or a polymeric carrier including an active agent or drug. An active agent can also be incorporated into the scaffolding of the stent.

A stent made from a biodegradable polymer is intended to remain in the body for a duration of time until its intended function of, for example, maintaining vascular patency and/or drug delivery is accomplished. After the process of degradation, erosion, absorption, and/or resorption has been completed, no portion of the biodegradable stent, or a biodegradable portion of the stent will remain. In some embodiments, very negligible traces or residue may be left behind. The duration can be in a range from about a month to a few years. However, the duration is typically in a range from about one month to twelve months, or in some embodiments, six to twelve months.

Representative examples of polymers that may be used to fabricate embodiments of implantable medical devices disclosed herein include, but are not limited to, poly(N-acetylglucosamine) (Chitin), Chitosan, poly(3-hydroxyvalerate), poly(lactide-co-glycolide), poly(3-hydroxybutyrate), poly(4-hydroxybutyrate), poly(3-hydroxybutyrate-co-3-hydroxyvalerate), polyorthoester, polyanhydride, poly(glycolic acid), poly(glycolide), poly(L-lactic acid), poly(L-lactide), poly(D,L-lactic acid), poly(D,L-lactide), poly(L-lactide-co-D,L-lactide), poly(caprolactone), poly(L-lactide-co-caprolactone), poly(D,L-lactide-co-caprolactone), poly(glycolide-co-caprolactone), poly(trimethylene carbonate), polyester amide, poly(glycolic acid-co-trimethylene carbonate), co-poly(ether-esters) (e.g. PEO/PLA), polyphosphazenes, biomolecules (such as fibrin, fibrinogen, cellulose, starch, collagen and hyaluronic acid), polyurethanes, silicones, polyesters, polyolefins, polyisobutylene and ethylene-alphaolefin copolymers, acrylic polymers and copolymers, vinyl halide polymers and copolymers (such as polyvinyl chloride), polyvinyl ethers (such as polyvinyl methyl ether), polyvinylidene halides (such as polyvinylidene chloride), polyacrylonitrile, polyvinyl ketones, polyvinyl aromatics (such as polystyrene), polyvinyl esters (such as polyvinyl acetate), acrylonitrile-styrene copolymers, ABS resins, polyamides (such as Nylon 66 and polycaprolactam), polycarbonates, polyoxymethylenes, polyimides, polyethers, polyurethanes, rayon, rayon-triacetate, cellulose acetate, cellulose butyrate, cellulose acetate butyrate, cellophane, cellulose nitrate, cellulose propionate, cellulose ethers, and carboxymethyl cellulose. Additional representative examples of polymers that may be especially well suited for use in fabricating embodiments of implantable medical devices disclosed herein include ethylene vinyl alcohol copolymer (commonly known by the generic name EVOH or by the trade name EVAL), poly(butyl methacrylate), poly(vinylidene fluoride-co-hexafluoropropene) (e.g., SOLEF 21508, available from Solvay Solexis PVDF, Thorofare, N.J.), polyvinylidene fluoride (otherwise known as KYNAR, available from ATOFINA Chemicals, Philadelphia, Pa.), ethylene-vinyl acetate copolymers, poly(vinyl acetate), styrene-isobutylene-styrene triblock copolymers, and polyethylene glycol.

Additionally, stents may also be composed partially or completely of biostable or bioerodible metals. Some metals are considered bioerodible since they tend to erode or corrode relatively rapidly when exposed to bodily fluids. Biostable metals refer to metals that are not bioerodible. Biostable metals have negligible erosion or corrosion rates when exposed to bodily fluids. Representative examples of biodegradable metals that may be used to fabricate stents may include, but are not limited to, magnesium, zinc, and iron. Biodegradable metals can be used in combination with biodegradable polymers.

Representative examples of metallic material or an alloy that may be used for fabricating a stent include, but are not limited to, cobalt chromium alloy (ELGILOY), stainless steel (316L), high nitrogen stainless steel, e.g., BIODUR 108, cobalt chrome alloy L-605, “MP35N,” “MP20N,” ELASTINITE (Nitinol), tantalum, nickel-titanium alloy, platinum-iridium alloy, gold, magnesium, or combinations thereof. “MP35N” and “MP20N” are trade names for alloys of cobalt, nickel, chromium and molybdenum available from Standard Press Steel Co., Jenkintown, Pa. “MP35N” consists of 35% cobalt, 35% nickel, 20% chromium, and 10% molybdenum. “MP20N” consists of 50% cobalt, 20% nickel, 20% chromium, and 10% molybdenum.

For example, a stainless steel tube or sheet may be Alloy type: 316L SS, Special Chemistry per ASTM F138-92 or ASTM F139-92 grade 2. Special Chemistry of type 316L per ASTM F138-92 or ASTM F139-92 Stainless Steel for Surgical Implants in weight percent. An exemplary weight percent may be as follows: Carbon (C) 0.03% max; Manganese (Mn): 2.00% max; Phosphorous (P): 0.025% max.; Sulphur (S): 0.010% max.; Silicon (Si): 0.75% max.; Chromium (Cr): 17.00-19.00%; Nickel (Ni): 13.00-15.50%; Molybdenum (Mo): 2.00-3.00%; Nitrogen (N): 0.10% max.; Copper (Cu): 0.50% max.; Iron (Fe): Balance.

FIG. 12 depicts an embodiment of a portion of a machine-controlled system for laser machining a tube. In FIG. 12, a tube 200 is disposed in a rotatable collet fixture 204 of a machine-controlled apparatus 208 for positioning tubing 200 relative to a laser 212. According to machine-encoded instructions, tube 200 is rotated and moved axially relative to laser 212 which is also machine-controlled. The laser selectively removes the material from the tubing resulting in a pattern cut into the tube. The tube is therefore cut into the discrete pattern of the finished stent.

The process of cutting a pattern for the stent into the tubing is automated except for loading and unloading the length of tubing. Referring again to FIG. 12, it may be done, for example, using a CNC-opposing collet fixture 204 for axial rotation of the length of tubing. Collet fixture 204 may act in conjunction with a CNC X/Y table 216 to move the length of tubing axially relatively to a machine-controlled laser as described. The entire space between collets can be patterned using a laser set-up of the foregoing example. The program for control of the apparatus is dependent on the particular configuration used and the pattern formed.

Machining a fine structure also requires the ability to manipulate the tube with precision. CNC equipment manufactured and sold by Anorad Corporation may be used for positioning the tube. In addition, a unique rotary mechanism may be used that allows the computer program to be written as if the pattern were being machined from a flat sheet. This allows both circular and linear interpolation to be utilized in programming. Since the finished structure of the stent is very small, a precision drive mechanism is required that supports and drives both ends of the tubular structure as it is cut. Since both ends are driven, they must be aligned and precisely synchronized, otherwise the stent structure would twist and distort as it is being cut.

FIG. 13 depicts a general schematic of a laser system that may be used for laser machining of stents. FIG. 13 includes an active medium 250 within a laser cavity 254. An active medium includes a collection of atoms or molecules that are stimulated to a population inversion which can emit electromagnetic radiation in a stimulated emission. Active medium 250 is situated between a highly reflective mirror 258 and an output mirror 262 that reflects and absorbs a laser pulse between the mirrors. Arrows 260 and 266 depict reflected laser pulses between cavity 254. Arrow 274 depicts the laser pulse transmitted through output mirror 262. A power source 274 supplies energy or pumps active medium 250 as shown by an arrow 278 so that the active medium can amplify the intensity of light that passes through it.

A laser may be pumped in a number of ways, for example, optically, electrically, or chemically. Optical pumping may use either continuous or pulsed light emitted by a powerful lamp or a laser beam. Diode pumping is one type of optical pumping. A laser diode is a semiconductor laser in which the gain or amplification is generated by an electrical current flowing through a p-n junction. Laser diode pumping can be desirable since efficient and high-power diode lasers have been developed and widely available in many wavelengths.

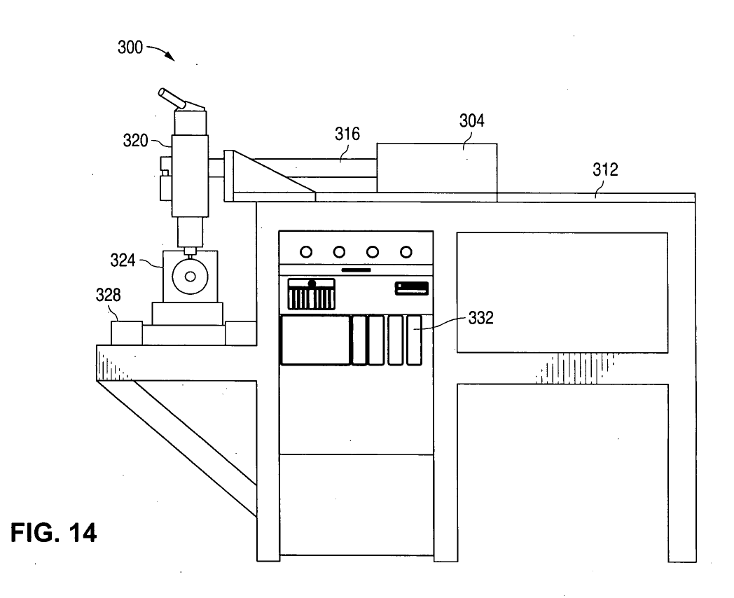

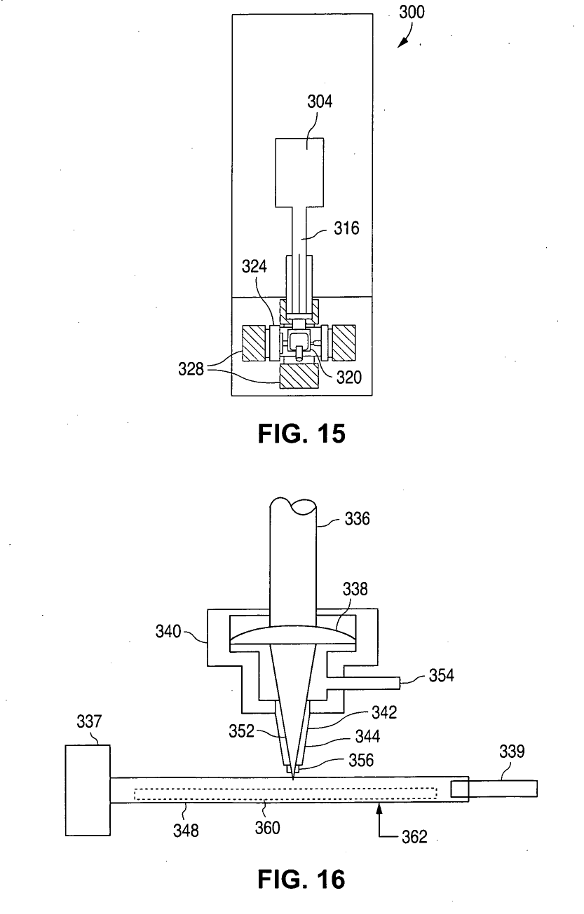

FIGS. 14-16 illustrate a process and apparatus, in accordance with the present embodiments, for producing stents with a fine precision structure cut from a small diameter thin-walled cylindrical tube. FIG. 14 depicts a side view of a laser machining apparatus 300 and FIG. 15 depicts an overhead view of apparatus 300. Cutting a fine structure (e.g., a 0.0035 inch web width (0.889 mm)) requires precise laser focusing and minimal heat input. In order to satisfy these requirements, an improved laser technology has been adapted to this micro-machining application according to the present embodiments.

FIGS. 14 and 15 show a laser 304 (e.g., as shown in FIG. 13) that is integrally mounted on apparatus 300. A pulse generator (not shown) provides restricted and more precise control of the laser's output by gating a diode pump. By employing a pulse generator, laser pulses having pulse lengths between 10 and 500 femtoseconds are achieved at a frequency range of 100 to 5000 Hz. The pulse generator is a conventional model obtainable from any number of manufacturers and operates on standard 110 volt AC.

Laser 304 operates with low-frequency, pulsed wavelengths in order to minimize the heat input into the stent structure, which prevents thermal distortion, uncontrolled burn out of the stent material, and thermal damage due to excessive heat to produce a smooth, debris-free cut. In use, a diode pump generates light energy at the proximal end of laser 304. Initially, the light energy is pulsed by the pulse generator. The pulsed light energy transmissions pass through beam tube 316 and ultimately impinge upon the workpiece.

Additionally, FIGS. 14 and 15 show that apparatus 300 incorporates a monocular viewing, focusing, and cutting head 320. A rotary axis 324 and X-Y stages 328 for rotating and translating the workpiece are also shown. A CNC controller 332 is also incorporated into apparatus 300.

FIG. 16 depicts a close-up axial view of the region where the beam interacts with the material and the process gas. A laser beam 336 is focused by a focusing lens 338 on a tube 348. Tube 348 is supported by a CNC controlled rotary collet 337 at one end and a tube support pin 339 at another end.

As shown by FIG. 16, the laser can incorporate a coaxial gas jet assembly 340 having a coaxial gas jet 342 and a nozzle 344 that helps to remove debris from the kerf and cools the region where the beam interacts with the material as the beam cuts and vaporizes a substrate. Coaxial gas jet nozzle 344 (e.g., 0.018 inch diameter (0.457 mm)) is centered around a focused beam 352 with approximately 0.010 inch (2.54 mm) between the tip of nozzle 344 and a tubing 348.

It may also be necessary to block laser beam 352 as it cuts through the top surface of the tube to prevent the beam, along with the molten material and debris from the cut, from impinging on the inside opposite surface of tube 348. To this end, a mandrel 360 (e.g., approx. 0.034 inch diameter (0.864 mm)) supported by a mandrel beam block 362 is placed inside the tube and is allowed to roll on the bottom of the tube 348 as the pattern is cut. This acts as a beam/debris block protecting the far wall inner diameter. A close-up end view along mandrel beam block 362 shows laser beam 352 impinging on tube 348 in FIG. 17.

Hence, the laser of the present invention enables the machining of narrow kerf widths while minimizing the heat input into the material. Thus, it is possible to make smooth, narrow cuts in a tube with very fine geometries without damaging the narrow struts that make up the stent structure.

### EXAMPLES

The embodiments of the present invention will be illustrated by the following set forth examples. All parameters and data are not to be construed to unduly limit the scope of the embodiments of the invention.

The present examples are directed to laser machining a polylactic acid tube to form a stent. Laser machining was performed using two different process gases, air and helium.

First, laser machining was performed in air. A femtosecond Ti:Sapphire laser was used with a wavelength of 800 nm. The beam was collimated to an 8 mm beam diameter, thus, the beam diameter, D, on the focusing optic was 8 mm. The focal length, f, of the focusing optic was 100 mm. Therefore, the focal diameter on the material, Df (from Df=1.27*f*λ/D), is 0.5 mil (0.0125 mm). The focal diameter is the area of direct interaction of the laser on the target material.

The modeling studies of C. H. Fan et al. may be used to determine the lifetime of the plasma plume. β=10 for the beam. The length of the plasma plume was measured as +/−1 mm. Using FIG. 6 gives a +/−2 ps long plasma.

In the absence of induced plasma formation of a process gas, the kerf width of the laser is expected be 0.6 mil, the focal diameter on the material. The actual kerf width was found to be 2 mil. The results suggest that laser induced plasma is responsible for the increase in kerf width.

Second, laser machining was performed in helium to show that that the plasma plume was responsible for the increase in machined area. Helium has a significantly lower ionization threshold than air and the expected lifetime of the plasma plume is approximately two picoseconds. Therefore, the shorter interaction time of the induced plasma with the material should create a smaller kerf width than with air. The results verified this prediction since the kerf width using helium was found to be 1.5 mil, compared with 2 mil for air.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

1. A method of laser machining a substrate for fabricating an implantable medical device, comprising:
inducing formation of a plasma plume from a process gas through interaction of the gas with a laser beam focused on a substrate; and
removing material in selected regions from the substrate by interaction of a plasma plume with the substrate,
wherein the substrate comprises a biostable or biodegradable polymer or combination thereof.

2. The method of claim 1, wherein the implantable medical device is a stent.

3. The method of claim 1, wherein a kerf width of removed material for the substrate is increased over a kerf width of removed material in an absence of a process gas.

4. The method of claim 1, wherein the substrate comprises a tubular member and removing the material forms a stent comprising a plurality of structural elements.

5. The method of claim 1, wherein the substrate comprises a biodegradable material.

6. The method of claim 1, wherein the laser beam has a pulse length between about 10 and about 500 fs.

7. The method of claim 1, wherein the laser beam has a pulse length of less than about 10 fs.

8. The method of claim 1, wherein the laser beam has a peak pulse power of at least about 50 megawatts.

9. The method of claim 1, wherein the process gas is selected from the group consisting of helium, oxygen, carbon dioxide, air, or combinations thereof.

10. The method of claim 1, wherein the process gas comprises helium.

11. An implantable medical device fabricated according to the method of claim 1.

12. A stent fabricated according to the method of claim 1.

13. A method of fabricating an implantable medical device, comprising:
directing a laser beam on selected regions of a substrate, the selected regions being adjacent or exposed to a process gas; and
allowing a plasma induced by interaction of the laser beam with the process gas to remove material from the substrates
wherein the substrate comprises a biostable or biodegradable polymer or combination thereof.

14. The method of claim 13, wherein the implantable medical device is a stent.

15. The method of claim 13, wherein a kerf width of the removed material is increased over a kerf width of removed material when directing the laser beam on the selected regions of the substrate in an absence of a process gas.

16. The method of claim 13, wherein the substrate comprises a tubular member and removing the material forms a stent comprising a plurality of structural elements.

17. The method of claim 13, wherein the substrate comprises a biodegradable material.

18. The method of claim 13, wherein an area of removed material is greater than an area of direct interaction of the laser beam with the substrate.

19. The method of claim 13, wherein the substrate comprises a tubular member and removing the material forms a pattern of interconnecting structural elements of a stent.

20. The method of claim 13, wherein the laser beam and the substrate are within a chamber containing the process gas.

21. The method of claim 13, wherein the laser beam is collimated and focused to a desired focus diameter on to the substrate.

22. The method of claim 13, wherein the laser beam has a pulse length between about 10 and about 500 fs.

23. The method of claim 13, wherein the laser beam has a pulse length of less than about 10 fs.

24. The method of claim 13, wherein the laser beam has a peak pulse power of at least about 50 megawatts

25. The method of claim 13, wherein the process gas is selected from the group consisting of helium, oxygen, carbon dioxide, air, or combinations thereof.

26. The method of claim 13, wherein the process gas comprises helium.

27. An implantable medical device fabricated according to the method of claim 13.

28. A stent fabricated according to the method of claim 13.

29. A method of fabricating a biodegradable stent, comprising:
directing a laser energy to a biodegradable substrate to form a scaffolding for a biodegradable stent, wherein the laser energy is directed in the presence of a process gas, wherein a kerf width of removed material for the substrate is increased over a kerf width of removed material when directing laser energy to the substrate in an absence of a process gas.

30-31. (canceled)
